(19) United States
(12) Patent Application Publication
(10) Pub. No.: US 2020/0385997 A1
(43) Pub. Date: Dec. 10, 2020

(54) CONCRETE BUILDING CLADDING ELEMENTS WITH INTEGRATED ANCHORS

(71) Applicant: ACKERSTEIN INDUSTRIES LTD., Herzlia (IL)

(72) Inventor: Gideon ARGAMAN, Hadera (IL)

(21) Appl. No.: 16/891,720

(22) Filed: Jun. 3, 2020

(30) Foreign Application Priority Data
Jun. 6, 2019 (IL) 267153

(51) Int. Cl. E04F 13/08; B28B 23/00

(52) U.S. Cl. CPC E04F 13/0833; B28B 23/005

(57) ABSTRACT

The present invention pertains to integrated machine for manufacturing anchor embedded cladding elements. Essentially, this machine comprises a cladding block manufacturing machine and anchor feeding and embedding machine, where the concrete block manufacturing machine and anchor feeding and embedding machine are configured for coordinated operation for producing anchors embedded cladding elements comprising concrete blocks and anchors embedded within said blocks. The flexibility and versatility of the machine is in determining the end location of the anchors in the final cladding elements before even manufacturing the cladding blocks. This provides greater degree of freedom, which in turn allows increasing the strength in fixing the cladding elements to a support wall on the one hand, and decreasing onsite or prefabrication workload and difficulties in the cladding process.

### TECHNICAL FIELD

The present invention pertains to cladding element for walls of buildings. Particularly, the present invention pertains to improved integrated machinery, means and methods for manufacturing covering elements for walls of buildings with concrete cladding blocks and a plurality of embedded anchors in predetermined configuration, number and distribution.

### BACKGROUND

The increasing shortage in natural stone cladding elements for buildings drives the construction industry towards industrialised cladding elements to fill the growing need in this area. Industrialised stones are manufactured and cured, and then are used to cover the external sides of walls of buildings. This significantly lowers costs without compromising on stone quality. The cladding method itself is, however, difficult, because the cladding blocks have to be stably fixed to the support walls and endure stress-strain changes during the lifetime of the building.

Current cladding methods drill holes at the sides of the cladding blocks, to which fastening anchors are introduced and connected to an intermediate steel net between the blocks and support wall. The anchors themselves are bent towards the net. Fresh mortar is then poured into the space that accommodates the net between the blocks and wall and covers the net and bent part of the anchors. Such method carries certain disadvantages, particularly in the difficulty in implementing this method onsite, and employing significant workforce. Another disadvantage is the limited flexibility in determining the location and number of the anchors, which in turn also limits the strength in which the anchors hold the cladding blocks to the support wall.

More versatile, efficient and low cost method, machinery and means are thus required to overcome these shortcomings.

It is, therefore, an object of the present invention to provide integrated machinery for manufacturing cladding elements that comprise advance embedded anchors in predetermined number, distribution and configuration for fixing to a construction wall in a plant or onsite.

It is yet another object of the present invention to provide methods for prefabricating cladding walls or onsite cladding walls, where larger versatility and flexibility is provided in the number, distribution and configuration of the anchors that fix the cladding blocks to a support wall.

This and other objects and embodiments of the present invention shall become apparent as the description proceeds.

### SUMMARY

The present invention pertains to integrated machine for manufacturing anchor embedded cladding elements. Essentially, this machine comprises a cladding block manufacturing machine and anchor feeding and embedding machine, where the concrete block manufacturing machine and anchor feeding and embedding machine are configured for coordinated operation for producing anchors embedded cladding elements comprising concrete blocks and anchors embedded within said blocks.

The flexibility and versatility of the machine is in determining the end location of the anchors in the final cladding element before even manufacturing the cladding block. This provides greater degree of freedom, which in turn allows increasing the strength in fixing the cladding elements to a support wall on the one hand, and decreasing onsite or prefabrication workload and difficulties in the cladding process, and ensures that all anchors needed are there.

The anchors used are essentially three parts, one longer and one shorter legs and a bendable axis connecting them. This structure allows bending the anchors in 90° position between the legs and sticking them into freshly manufactured concrete cladd blocks. Then dedicated device may be used to lift the exposed leg, which is usually the longer one, up and use it to connect to a support wall through mediating elements, namely a steel net and cement poured in the space between the cladding elements and the wall.

The degrees of freedom in determining the number, distribution and configuration of the anchors in advance provide improved strength in fixing the cladding elements to a support wall and versatility and flexibility in adapting the required strength under varying conditions, including weather changes, gradual erosion, seismographic activity and general environmental conditions.

The machinery of the present invention is based on machinery for producing cladding blocks and an adaptable machine for arranging, mounting, loading, delivering and embedding anchors in the cladding blocks. Such integrated machinery requires that these two modules operate in coordination with each other. Essentially, the anchor related module is also adaptable to custom machines for manufacturing cladding blocks and may be arranged to work with them from mechanic and timing perspectives.

Different methods for cladding walls with cladding elements having anchors embedded in them are also contemplated within the scope of the present invention. Such methods are essentially divided between prefabrication and onsite methods. Both types of methods use essentially the same elements which are produced by the integrated machinery of the present invention.

In what follows and in accordance with the previous paragraphs, a detailed description of preferred non-limiting embodiments of the invention is disclosed for the product, method, machinery and elements for manufacturing the cladding blocks with integrated anchors without departing from the scope and spirit of the invention.

### BRIEF DESCRIPTION OF THE DRAWINGS

FIG. 1 illustrates a Hermetic Press machine for manufacture cladding elements in ongoing multi-stage process.

FIGS. 2A-G illustrate the different components of the Hermetic Press machine.

FIGS. 3A-H illustrate different views and aspects of the anchor, which is used to connect cladding elements to support walls of a building.

FIG. 4 schematically illustrates anchor feeding machine incorporated with the Hermetic Press machine for integrating anchors into cladding elements.

FIGS. 5A-C illustrate dedicated device for orienting anchors integrated into cladding elements and into vertical position before attachment to a support wall of a building.

FIGS. 5D-E illustrate top view of possible shapes of anchors for integration into cladding elements.

FIG. 6 illustrates cladding and thermal insulation on an outside wall.

FIGS. 7A-E illustrate different views and aspects of the anchor with addition of a blade for improved hold to the cladding block.

FIG. 8 illustrates the anchor with the addition of a hole at the distal end of its long part.

### DETAILED DESCRIPTION OF THE DRAWINGS

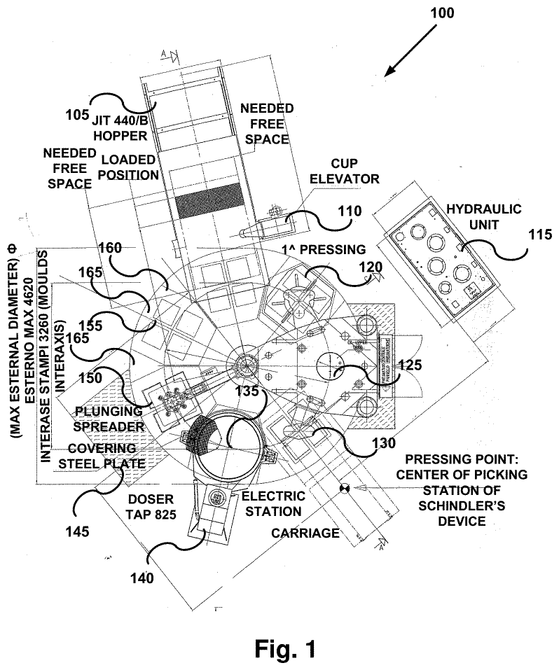

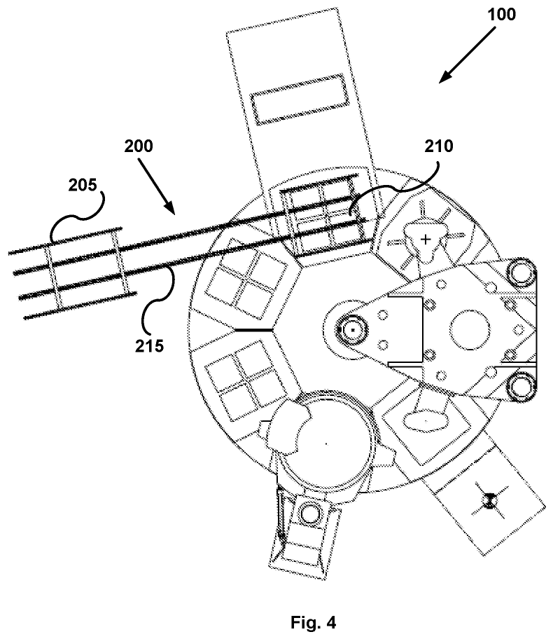

FIG. 1 schematically illustrates an exemplary Hermetic Press machine 100 for manufacturing concrete cladding blocks/elements. This machine operates in simultaneous multi-stage production of the blocks, using a revolving table with multiple trays that carry a plurality of plates for manufacturing the cladding blocks/elements. The following provides a general description of the operation of the Hermetic Press machine 100, into which an anchor feeding and embedding machine 200 (see FIG. 4) is incorporated.

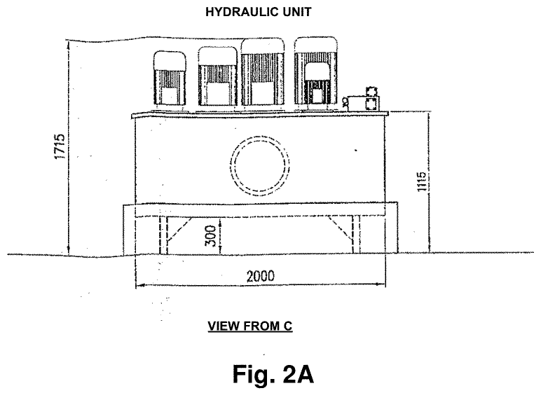

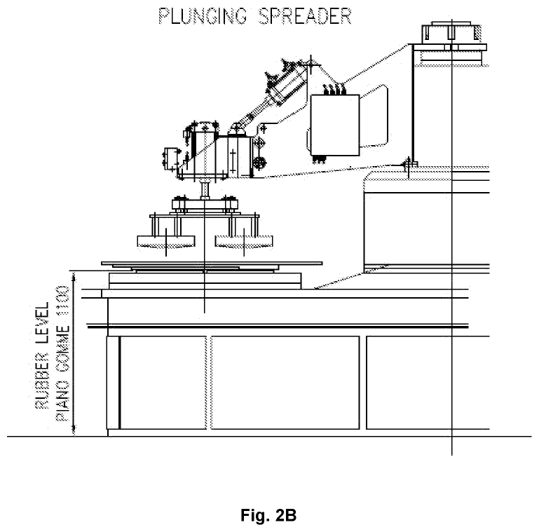

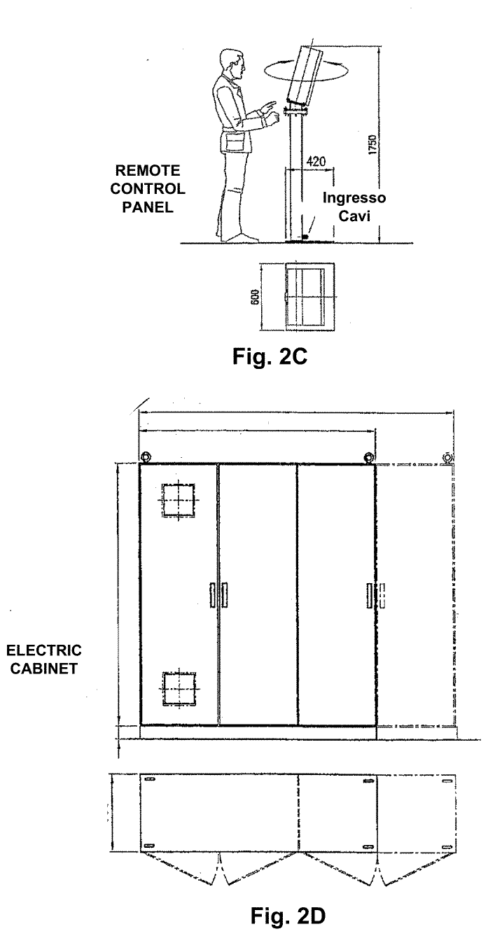

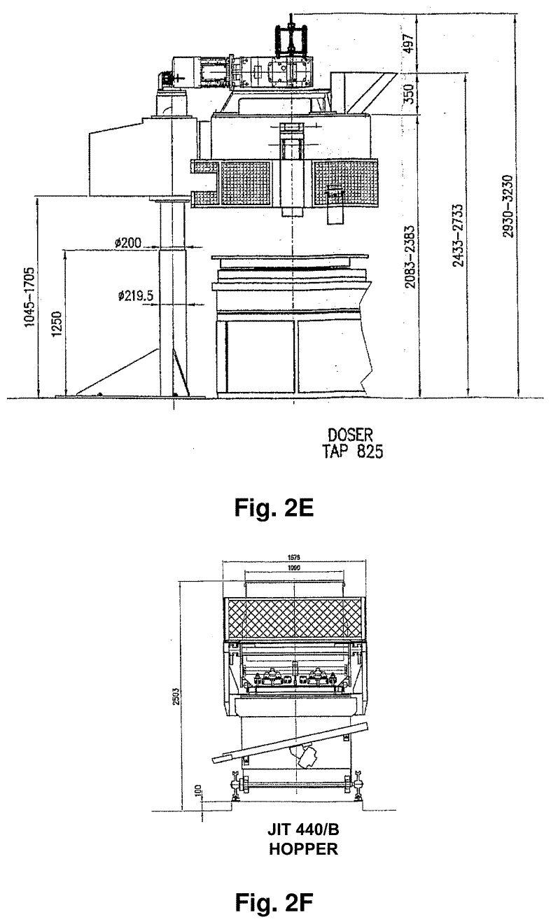

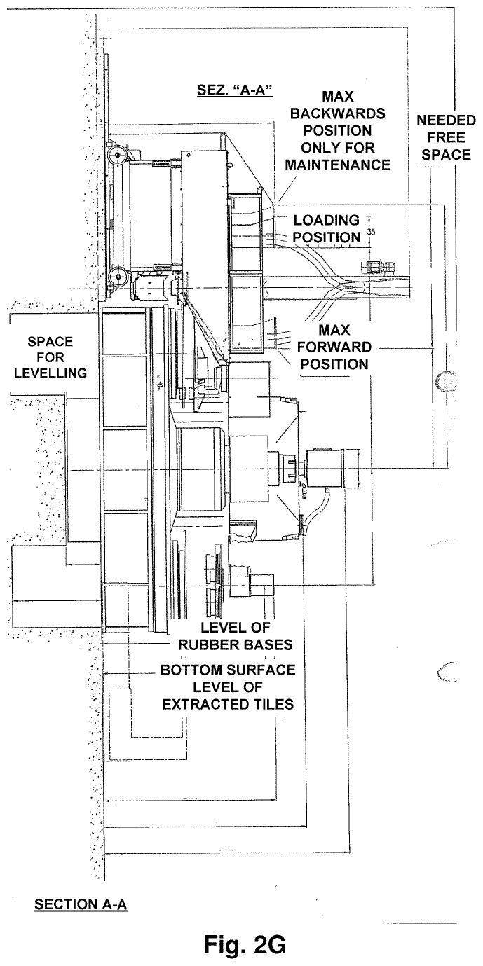

The particular parts of the Hermetic Press machine 100 are further illustrated in FIGS. 2A-G. The concrete blocks that the machine 100 produces mostly contain two layers of “wet” and “dry” concrete (by “dry” concrete is meant a relatively low amount of liquids in the concrete that enable faster drying), which are layered in serial manner. The “wet” concrete forms the front side of the cladding blocks/elements, and the “dry” concrete forms the back side of the element. The machine fills a pre-selected pattern with the “wet” and then “dry” concrete according to the dimensions of the pattern. Then it presses (the concrete layers) with a hard-press. Along this general line of production, the machine manufactures a plurality of block units every single revolution of the main table 160 that carries a plurality of trays, every tray containing a plurality of plates 155, which are fit for filling with the concrete layers.

The process of producing double-layer concrete cladding blocks is carried out according to the following general steps:
feeding “wet” concrete into plates 155 and filling them with a pre-determined amount;
spreading the “wet” concrete in the plates by vibration;
feeding “dry” concrete into plates 155 and filling them with a pre-determined amount;
pressing the double-layer concrete blocks, which are formed;
unloading and releasing the blocks; and
packaging the concrete blocks.

The following relates to the general illustration of the machine 100 and its particular parts in FIGS. 2A-G. At station 140, “wet” concrete is fed with Doser Tap 825 to the plates 155, then leveled and spread through at vibration stations 165. The table makes partial revolution to move the partly filled plates to station at the distal end of JIT 440/B HOPPER 105 (see also FIG. 2F). A feeding inlet 105 (see also FIG. 2F) drives “dry” concrete batch to the revolving table and feeds the plates 155, which are stationed at the distal end, with a predetermined amount of the “dry” concrete. Cup elevator 110 is used to return spilled concrete to the plate in overfilled situations. The table 160 then makes partial revolution to advance the tray with the partly filled plates 155 to the next stop 120 of preliminary press. The plates 155 filled with “wet” and “dry” concrete layers are moved to main press 125, which pushes out unnecessary air in the layer and generates a denser, more tightened, “dry” concrete layer under selected pressure level. After ensuring that the “dry” concrete forms well-defined blocks in the plates, the complete two layer blocks are moved to station 130 for pulling-off and unloading. Revolution of the table 160 and generally movement of the trays between stations in the machine 100 is done with an electric motor (not shown). Hydraulic unit 115 is used to operate the presses and unload the concrete blocks. An efficient manufacturing process of multi-layer concrete blocks is achieved by mounting multiple trays on the revolving table, where each tray contains a plurality of plates that fit for producing the concrete blocks.

After pressing the cladding blocks are taken out, released from the plates and moved out with electro-mechanical vacuum assisted systems. Then they are placed on dedicated steel pallets. The elements, namely cladding concrete blocks, on the steel surfaces are then moved to curing chambers. Finally, after curing the steel pallets with the cladding blocks are taken to unloading and packaging.

This covers the basic general process for manufacturing cladding blocks, which are used in the present invention. The different modules of the Hermetic Press machine 100 are generally illustrated in FIGS. 2A-G, including operator control station, FIG. 2C, electric cabinet, FIG. 2D, Doser Tap 825, FIG. 2E, for feeding the “wet” concrete, Hopper, FIG. 2F, for feeding the “dry” concrete and a cross-section illustration of the entire machine 100, FIG. 2G.

It should be noted that this Hermetic Press machine is exemplary for means and methods for manufacturing cladding concrete blocks, but other similar or different machines may qualify and are contemplated within the scope of the present invention. For example, machines with “linear” production methods, namely without a revolving table and with an identical or similar production process, considering the final result, may also be used in the present invention for producing cladding blocks/elements and integrating anchors within them.

In one particular embodiment, the cladding block has a thickness between 25 mm and 35 mm, and is made of two concrete layers: one “top” layer with a thickness of about 10 mm, a second “bottom” layer with a thickness of 15 mm to 25 mm. In a further embodiment, the two-layer concrete comprises aggregates and sand in different sizes, type and level of content of cement, additives and water. In a further embodiment, colorants are added to the mixture that forms the concrete of the two layers to obtain a desired shade or hue.

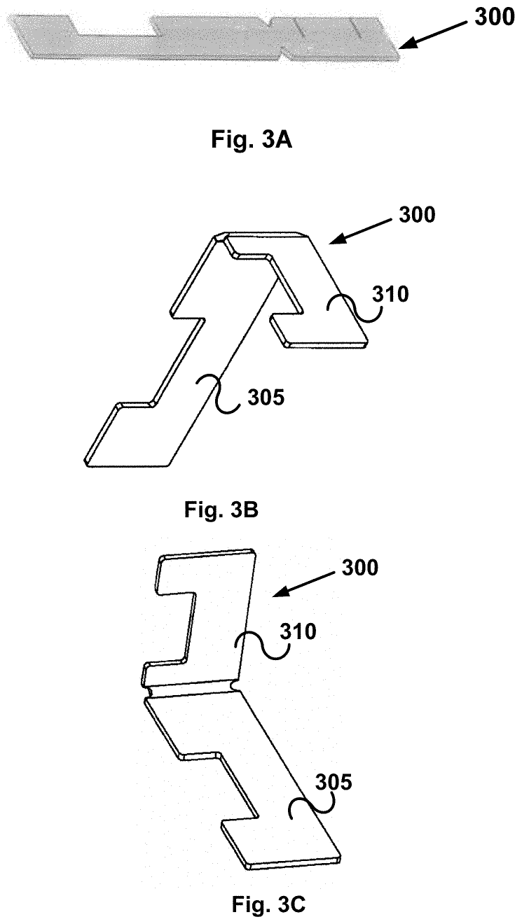

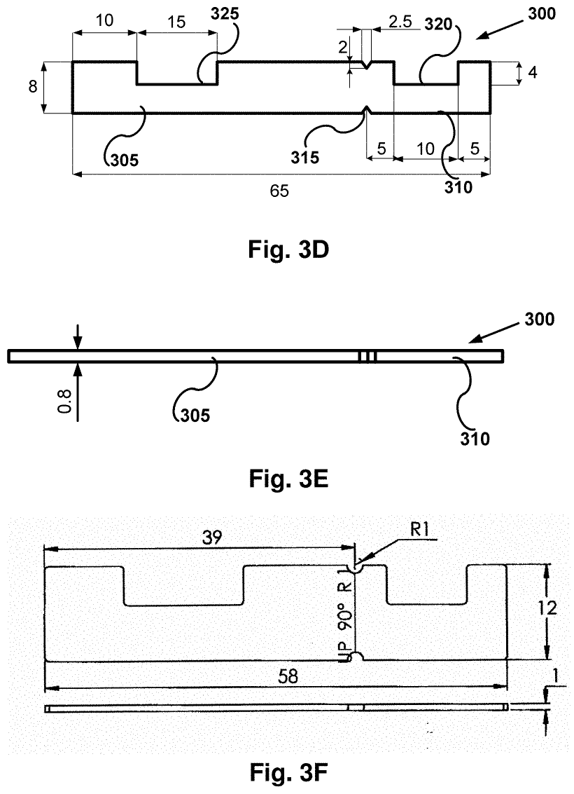

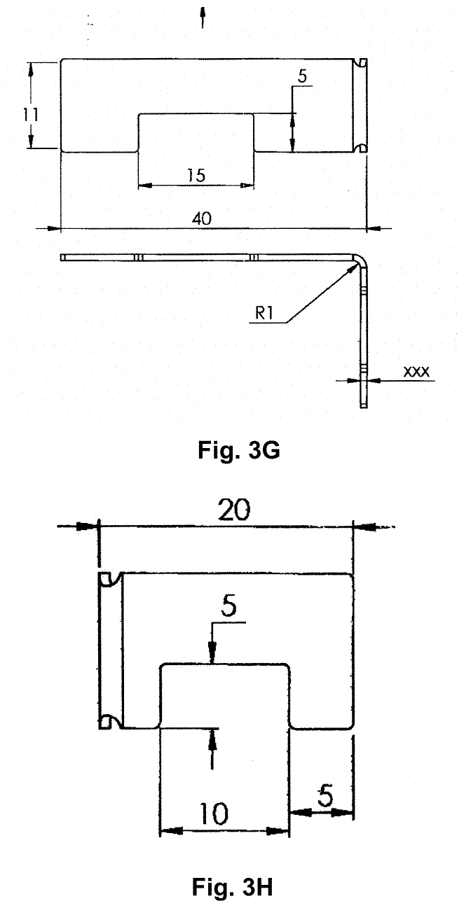

To produce an element, namely a concrete cladding block, with integrated anchors, the anchors are fed into the Hermetic Press machine 100 such that they are eventually placed in exactly pre-selected locations at the cladding block. These anchors (which are fed in 90° bent position, see FIGS. 3A-C) are released onto the “dry” concrete layer and moved to the stage in the first, initial press, in which they are submerged into the “dry” layer. Then, in the following stage, the anchors are fixed within the “dry” layer by further pressing with the main press. At the end of pressing, the horizontal upper surface of the submerged anchor is leveled with the surface/height of the concrete. The following step is unloading the (pressed) element, which is carried out automatically in a regular manner by the Hermetic Press machine 100.

The delivery of the anchors to the press machine 100 is done with complementing anchor feeding and embedding machine 200 for embedding the anchors in the concrete blocks. An exemplary machine 200 is schematically illustrated in FIG. 4. Machine 200 comprises a base 205, a guiding beam or arm 215 and a carrying feeding device 210 that carries the anchors for introducing into the “dry” concrete layer after the Hermetic Press machine 100 completes a revolution of manufacturing a batch of two-layer, “wet” and “dry”, concrete cladding blocks. Anchors are mounted on a tray, which is placed on base 205 of the complementing anchor embedding machine 200, in a particular configuration and at 90° bent position. Such configuration on the trays is selected to match the desired number, location and/or distribution in the cladding blocks themselves. Every such tray is essentially designed with grooves at particular locations in the image of distribution of the anchors in the concrete block. This is so that when the anchors are released from device 210 they are placed in those locations, which are pre-selected to accommodate them in the concrete block. Essentially, this method provides a wide range for organizing the anchors in the cladding elements according to particular construction requirements that take into account parameters such as material strength of the cladding blocks, stability over time and impact of humidity and temperature on expansion and contraction of the elements. Another advantage over a method of introducing anchors after preparation of the blocks is that the block integrated anchors do not adversely affect expansion and contraction of the concrete under thermal, pressure and/or humidity conditions. Anchors drilled into the concrete after preparing the blocks are more likely to cause local stresses and cracks, which may expand throughout the entire block with time.

The method of feeding the anchors in the exact places in the elements, namely cladding blocks that the Hermetic Press machine 100 produces may be done by configuring the grooves in which the anchors are placed on the tray. Such configuration should match the intended configuration of the anchors when embedded in the concrete blocks as shaped by the plates 155 that hold them. Further, coordination of the operation between the two machines, 100 and 200, and mounting and releasing mechanisms for arranging the anchors on the trays and dropping them exactly at their intended locations on the cladding blocks is also contemplated to ensure a supervised and regulated process. In preferred embodiments, the anchor embedding machine 200 is automatic, semi-automatic or divided between manual labour and machine operation. In still another embodiment, this machine 200 comprises the following components:
stabilizing base of the machine;
horizontal beam or arm, which is configured as guiding track for guiding a device that carries the anchors from the base above the plates;
a moving machine head device that comprises a lower plate with vacuum mouthpieces;
a static system (table) configured to hold a tray with anchors, which are located on it according to a plan of location of the anchors in an element;
a distal frame, which is connected to the horizontal beam/arm of the machine above a table that carries the cladding block plates;
a vacuum system;
a compressed air system.

The machine head device travels along a defined track along the beam/arm between its base at the point of pick-up of the anchors with vacuum means to the drop-off point at the distal frame above the cladding block plates. This allows holding the anchors in releasable positions by the machine head device and dropping them off when reaching matched position of the anchors tray above a plate of a cladding block. Accordingly, the anchor embedding machine 200 may further comprise means for measuring and identifying the locations and positions of the anchors which are held by the machine head device 210 relative to the location, dimension and position of the cladding block plate. This provides accurate orientation of the anchors relative to the plate of the cladding block and ensures proper placement in the concrete according to a selected configuration. The machine 200 may also comprise means for driving the machine head device 210 to and holding it in accurate position above the plate of a cladding block. This ensures that the anchors are dropped off at exactly their intended pre-planned locations in the block to complete the process and eventually provide the desired stress-strain profile for the particular wall with the cladding elements. In one particular embodiment, the anchors tray, which holds the anchors before pick-up is made of a material selected from aluminium, metal or metallic materials, synthetic polymeric materials (polymer) and any combination thereof. In another particular embodiment, the tray matches the dimensions of the plate of the machine for the elements produced, namely anchors integrated cladding blocks. To hold the anchors in place, such anchors tray comprises slots in which 90° bent anchors are threaded. In one particular embodiment, threading the anchors is done manually before the manufacturing process initiates, so that a tray filled with bent anchors is provided to the machine when the cladding block is finished. In still another embodiment, the anchors are automatically stacked and fed in serial form and unloaded onto the cladding block according to computer generated and controlled plan. In still another embodiment, the anchors are automatically fed and placed on the trays in a particular selected configuration, which is computer generated and controlled. In these the machine beam or arm 200 and device 210 are maneuvered according to computer or controller commands for loading the anchors on the trays, traveling towards and above the concrete cladding block plates and unloading the anchors according to a selected location plan.

The machine head device 210 travels the distance along the beam/arm 215. In an alternative embodiment, the beam or arm 215 turns on its main axis and brings the device 210 to place above the plates 155 that contain the freshly produced cladding blocks. The machine head device 210 travels together with vacuum and compressed air system, where the vacuum system comprises vacuum mouthpieces for pulling the anchors off of the tray and arriving above plates 155 to fixed position. The anchors are caught by the mouthpieces with the vacuum mouthpieces. At the base of the machine 200, the empty tray is removed from the table and replaced with a filled tray or the emptied tray is filled again.

In one embodiment, different configurations of slots are made on the trays for embedding anchors in corresponding locations in the element. The different slots may be marked, for example with color, to distinguish between the different slot configurations on the trays. This ensures the matching of corresponding load and placement of the correct anchors that belong to a particular configuration, which is intended for a particular element together with double or more use of the same tray for multiple elements. In still another embodiment, the trays are provided in sufficient number, for example tens or hundreds of units, so that the rate of production in the machine is not compromised or slowed down due to slow load (of anchor units). As a result, the number of trays compensates the loading time of anchors on the trays and ensures an ongoing process of manufacturing the cladding blocks and embedding anchors in them to produce the anchor embedded cladding elements of the present invention. In one particular example, the production rate in the machine is between 15 and 30 seconds per cycle.

The mechanism for holding, travelling and dropping off of the anchors by machine 200 is as described above. Particularly, the machine head is equipped with vacuum system to pull the anchors off of the tray, hold, lower towards and push them onto the upper surface of the cladding block. The vacuum system comprises vacuum mouthpieces mounted on the machine 200 head, which are used to pull the anchors off upon application of vacuum, when arriving at the destination above the cladding blocks. The machine head moves backwards and the head is stabilized above the filled tray. A lower plate with the vacuum mouthpieces is pressed downwards with air pressure towards springs. Then the vacuum system is operated and the anchors are caught by the mouthpieces. The lower plate moves up by releasing air pressure and the action of the springs. Then the head travels on the beam towards the cladding block plates on machine 100 (in proper timing) and arrives above the concrete “lower”, “dry” layer in the filled plate. Upon arriving, the lower plate is pressed by air pressure, goes down on the anchors above the cladding block surface and pushes them in so that the vertical ends of the anchors are easily and smoothly partially stuck in the block concrete. Specifically, the horizontal part 305 (see FIGS. 3A-H and 5D-E) is slightly embedded beneath the surface of the block so as not to protrude but still be accessible for lifting up. At this stage the vacuum is released leaving the anchors in the block. The air pressure is reversed and the lower plate goes up (the move is of several centimetres). At the end of anchors embedding operation, the head travels back again for reload of anchors.

Specifically, the vacuum mouthpieces are located according to the desired final locations of the anchors in the cladding block. These locations can be modified according to the locations and number of anchors and their configuration on the anchors tray. Other parameters may be considered when determining the anchors configuration and corresponding configuration of vacuum mouthpieces such as the size and dimensions of the cladding block. Air pressure is generated by a compressed air system that uses springs or inflating and deflating air bags to push down and pull up the machine head over the lower plate.

In one embodiment, mechanical or magnetic means are used in the machine head device for lifting the anchors off of the tray and releasing them in the cladding blocks. Particularly, magnet couplings or electromagnet, in which alternating electrical current generates magnetic field, may be used to attract the anchors up from the tray, hold them while traveling along the beam/arm and release them into the cladding blocks at the distal end. Magnetized metal is used in the anchors for use of such magnetic means to hold and shift them from the tray to the cladding block.

The combination of any press machine and the anchor feeding and embedding machine of the present invention requires accurate positioning and synchronizing between the machines to press the anchors in their proper place in the concrete claddings. Particularly, the exemplary anchor feeding and embedding machine 100 is positioned in a particular position relative to the Hermetic Press Machine 200 and synchronized with the latter cycle of production to introduce the anchor carrying trays into a selected station at a particular time interval of this cycle. The relative positioning and configuration of these two machines should be so designed to manufacture uniform anchor embedded claddings. Accordingly, machine 100 should be leveled relative to machine 200 in particular distance, height and angle to allow secure delivery, positioning and locking of the anchors to the claddings. Adapting machine 100 to any production line of claddings is, therefore, unique to the particular characteristics of machine 100 and the particular features of the machine for manufacturing the claddings. The following exemplifies the coordinated operation of machine 200 and machine 100 and details how it is carried out:
1. Hermetic Press machine 200 manufactures claddings on a revolving table containing seven templates, each template containing several cladding elements. The revolving table passes between several stations, where each station is responsible for a specific step and action:
   1) Station 1—Filling “wet” concrete of the outer part of the cladding. “Wet” concrete means liquid-like phase concrete with cement/water ratio of 0.4 or higher.
   2) Station 2—Vibrating the templates for leveling the “wet” concrete over the templates' bottom surface.
   3) Station 3—Inspecting the filling of the “wet” concrete.
   4) Station 4—Filling the templates with “dry” concrete. “Dry” concrete means concrete which is not in liquid-like state, with low relative amount of water, specifically 0.4 water/cement ratio or lower. This concrete serves as the rear side of the cladding. It is condensed in the production process over the “wet” concrete inside the template. In this condensation, it absorbs part of the water of the “wet” concrete, thus forming a single solid cladding unit from the two “wet” and “dry” concrete layers.
   5) Station 5—First press—the fresh claddings are pressed with 80 tons weight press for leveling their outer surface.
   6) Station 6—Main press—after leveling, a 1,200 ton weight press condenses the concrete and elevates excess water from the “wet” concrete into the “dry” concrete.
   7) Station 7—The fresh claddings are taken out of the template to an automatic tray and transported by vacuum system to a stainless steel plate and from there to a finishing zone.
2. Station 4 in the process of manufacturing the claddings open a way to introduce the integral anchors so that they will be fasted within the cladding concrete at stations 5 and 6. The fasting of the anchors in the concrete is carefully planned to balance between embedding their vertical leg within the concrete and leaving their horizontal leg exposed on the surface of the cladding.
   The presence of “dry” concrete allows the application of the anchors. Otherwise, the anchor embedding machine would not have been able to fix them in place in a cladding with only “wet” concrete.
3. In Station 4, the “dry” concrete is filled into a template with a “filling basket” that contains “dry” concrete. The basket moves back and forth, and its conveyor drives and distributes the concrete evenly within the template.
4. The synchronizing between the operations of the anchor embedding machine and the cladding manufacturing machine takes place at this stage. The is because only when the filling basket travels back and clears the space above the template with the “dry” cladding can the anchor embedding machine introduce its arm that carries the anchors and lower them down into the “dry” concrete with a light push.
5. The pass time between stations is only 15-20 seconds, which requires the anchor embedding machine to work in precise timing according to the schedule of the cladding manufacturing machine.
6. The available time interval for introducing the arm of the anchor embedding machine over the cladding template is only between 5 and 10 seconds. Such short time requires that the arm be efficiently designed to match the design of the cladding manufacturing machine for accurate in and out traveling.
7. The in and out traveling of the arm of the anchor embedding machine and the revolving of the table of the cladding manufacturing machine should be completely coordinated so that the arm enters in the correct station and leaves before the table revolves to the next one.
8. Such coordination is achieved by communicating between the control of the cladding manufacturing machine and the control of the anchor embedding machine.
9. The entry of the arm into the working zone of the cladding manufacturing machine is possible only at station 4 and only in a relative position of a few centimeters above the template.
10. The design and performance of the anchor embedding machine and its cooperation with the cladding embedding machine requires very high precision, coordination and synchronization between all parts of the systems as well as accurate positioning one relative to the other.
11. Introducing the anchors into the “dry” concrete at station 4 is made possible by vertical movement of the tray that holds them with vacuum mouthpieces. Particularly, the longer horizontal leg is held with vacuum, while the shorter vertical leg extends downwards. The downward movement takes only a few centimeters.
12. Complete coordination takes place also between the beginning of revolving of the cladding manufacturing machine (the Hermetic Press) and a safe exit of the arm of the anchor embedding machine.
   The coordinated and synchronized operation of the anchor feeding and embedding machine and cladding block manufacturing machine leads to embedding the anchors in the “dry” concrete layer by application of selected pressure to introduce one part of the anchor into the “dry” concrete layer and maintain another part of the anchors exposed on the surface of the “dry” layer and leveled with that surface. Once embedded, the means of the anchor feeding and embedding machine, mainly its arm or beam are retreated out of the concrete cladding manufacturing machine before the latter moves its table that carries the cladding plates to the next station in the production line.

Holding, carrying and releasing the anchors with vacuum means may be done in the following method:
applying air pressure on springs or filling air bags to push the machine head device down on the tray in which the anchors are ordered in a particular configuration;
applying vacuum on the anchors and lifting them off of slots in which they are placed on the tray with vacuum mouthpieces;
applying release air pressure for lifting the machine head device off of the tray;
applying air pressure on springs or filling air bags to push the machine head device down on the cladding blocks;
releasing the vacuum off of the vacuum mouthpieces; and
applying release air pressure for lifting the machine head device off of the cladding blocks.

Similarly, holding, carrying and releasing the anchors with magnetic or electromagnetic means may be done in the following method:
applying air pressure on springs or filling air bags to push the machine head device down on the tray in which the anchors are ordered in a particular configuration;
generating magnetic field for magnetizing the anchors and lifting them off of slots in which they are placed on the tray;
applying release air pressure for lifting the machine head device off of the tray;
applying air pressure on springs or filling air bags to push the machine head device down on the cladding blocks;
shutting said magnetic field off and releasing the anchors into the cladding blocks; and
applying release air pressure for lifting the machine head device off of the cladding blocks.

The machine is guided by electricity and control system, and operates in coordination with the control system of the machine 100 for manufacturing the cladding blocks.

Exemplary non-limiting illustrations and dimensions of the anchors are shown in FIGS. 3A-H. One typical structure of anchor 300 comprises two main parts, 305 and 310, where the two parts are connected to each other with bendable axis 315. Before loading the anchors 300 on the anchor tray, parts 305 and 310 are oriented 90° one relative to the other by bending axis 315 between them. This way, the anchors are introduced into the cladding block in 90° position, which later enables using part 305 to connect with and hold to a support wall of a building. Generally, the shorter part 310 is embedded in the “dry” concrete block of the cladding block, and the longer part 305 is used to fasten to the support wall. Recesses 325 and 320 are used for non-uniform non-flat surface of the anchor, thereby increasing friction with the cement of the support wall and concrete of the cladding block, respectively, which enhances adherence and structural stability and strength. In another particular embodiment, the surfaces of the anchors may be in any non-flat shape such as, wavy, serrated or roughened to increase such friction and structural strength.

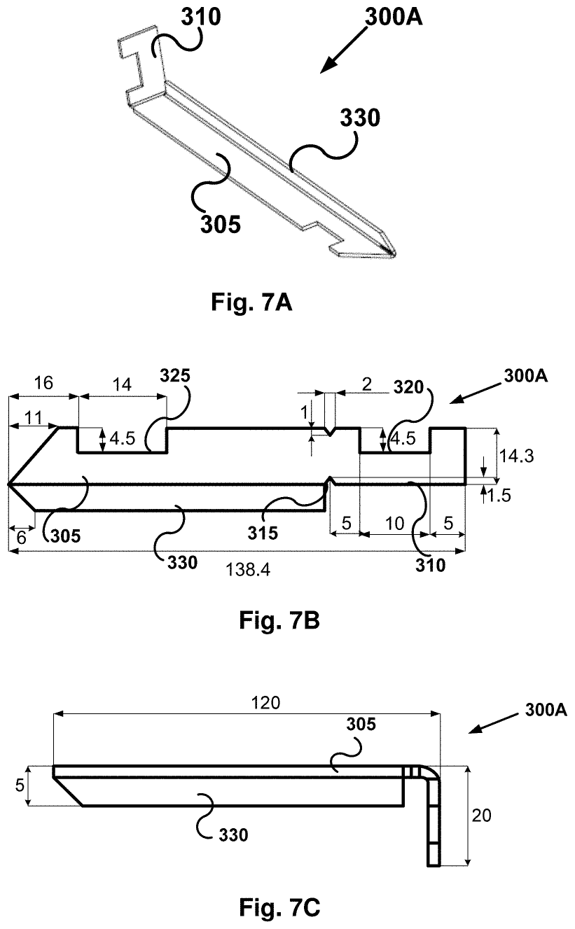

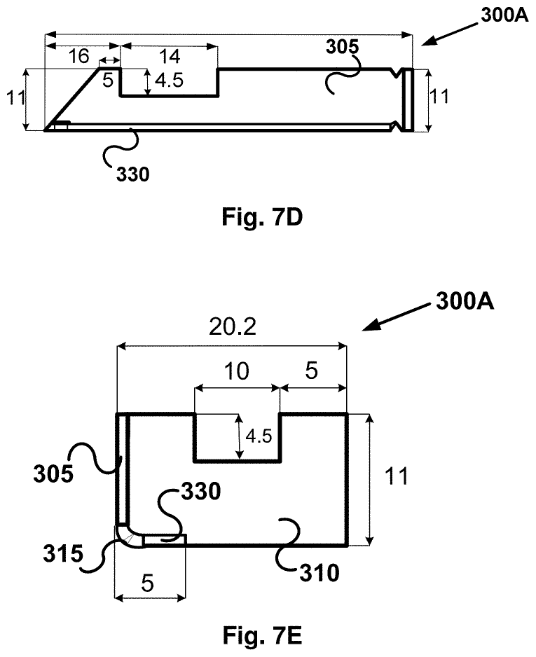

FIGS. 7A-E show another embodiment of the anchor 300, namely 300A, with additional side blade, 330, that connects in 90° relative to the longer part 305 of the anchor on the X-Y plane. As a result, side blade 330 is 90° relative to the shorter part 310 of the anchor in the Y-Z plane. The blade has inclined sharp edge at its distal end and a proximal side that is disconnected from the bending axis 315 and the short part of the anchor. The makes the blade connected only to the longer part 305 of the anchor. When embedded, the blade 330 is introduced into the bulk of the cladding block together with the shorter part of the anchor 310, thereby providing additional strength to fixing the anchor in place. Further, the blade is pulled out of the cladding block when the longer part 305 of the anchor is straightened for fixing the block to a support wall. The blade is then inserted to the support wall together with the longer part, thus providing additional strength to holding the block. Thus, the blade's contribution is twofold. Its right angle relation with the shorter part 310 on the Y-Z plane increases the anchor's resistance to pulling out of the cladding block. Its right angle relation with the longer part 305 on the X-Y plane increases the anchor's hold to the support wall when the longer part is straightened and fixed to the wall. Further, the blade also improves the distribution of the load of the block on the support wall, thus decreasing the probability of detachment of the block off of the wall.

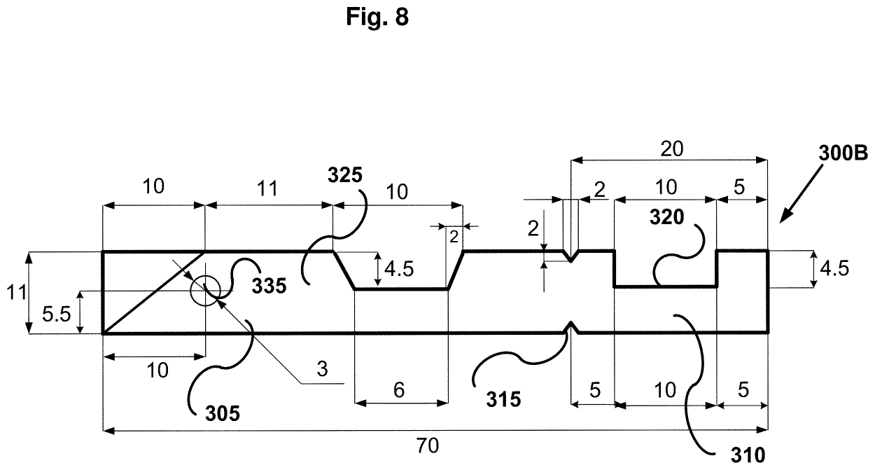

FIG. 8 shows another embodiment of the anchor 300B with a hole 335 at the distal end of its long part. Hole 335 may be used to enhance the connection of the anchor 330B to a metal grid, which is overlaid on the support wall, by inserting a thread or wire through it and tying the thread or wire to the grid after pulling the long part of the anchor to vertical position. Such tying mechanically strengthens the attachment of the cladding block to the support wall in addition to cement or adhesive layer between the wall and block. As a result, the cladding block is fixed to the wall in at least two different modes of attachment, which ensures it remains permanently attached to the wall.

In one particular embodiment, the anchors are made of stainless steel according to regulations with thickness of between 0.6 and 1.0 mm, or customized according to demand. The width of the anchors is between 8 and 12 mm, however any other width may also be suitable. The length of the anchor vertical part which is stuck in the concrete is 20 mm, the length of the anchor horizontal part (designed to be covered by cast concrete of the wall) is 60 mm or any other dimension that fits the plan for the particular construction. The anchors comprise recesses to enable stronger adherence to the concrete in both sides, namely the element and wall.

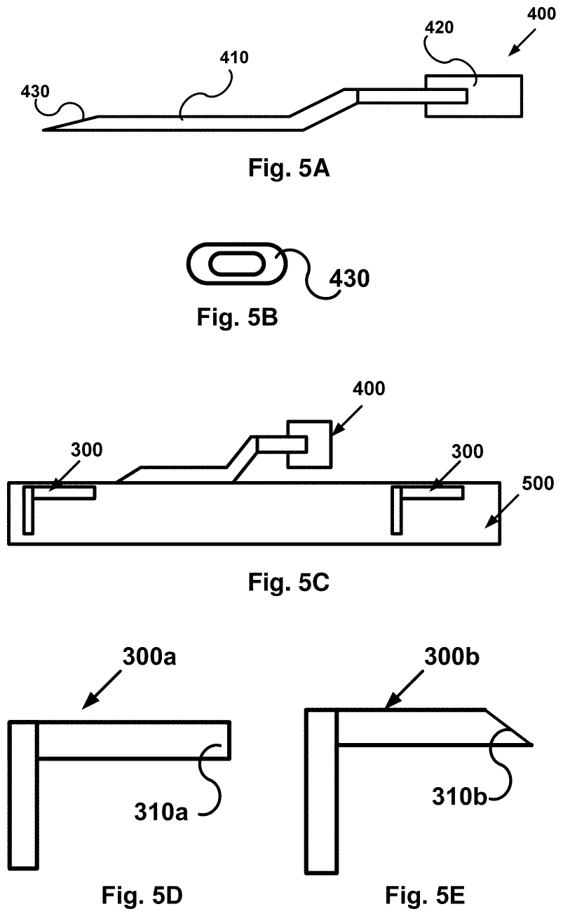

Before placing the cladding elements, i.e., cladding blocks with embedded anchors, at the construction site, the horizontal part of the anchor is lifted vertically relative to the element surface. A dedicated device such as the one 400 illustrated in FIGS. 5A-C is designed for this operation. Such a device comprises a “blade” element 410 with a tip 430 which is designed in shape, inner space and curvature, see FIG. 5B, to slide between the anchor 300 and cladding block 500 and apply sufficient force to lift the horizontal part 305 of the anchor 300 vertically. A holding handle 420 is attached to the distal end of the blade 410 and is particularly designed for convenient ergonomic holding.

In manual lifting of the anchor's exposed part 305, the worker pushes the edge of the “blade” 430 under the anchor and separates between the anchor and concrete (of the element). The “blade”, which is composed of a stainless steel tube, sharpened at the edge, and with width that fits the anchor, slides under the part 305 of the anchor between this part and the surface of the block and with a simple action, a worker aligns the anchor (horizontal part) to vertical position.

Particular exemplary non-limiting embodiments in FIGS. 5D and 5E illustrate edges 310a and 310b of respective horizontal parts 300a and 300b of selected designs of the anchor. The edge may be flat, 310a, or inclined sharp, 310b. Particularly, with a sharp edge, 310b, the device 400 is only at a single first contact point with the horizontal part 300b of the anchor. As a result, the device 400 does not have to be pushed under an edge front to lift the horizontal part, e.g., 310a, which makes it is easier for the worker to handle onsite.

### Application of the Cladding Element

In one preferred embodiment, application is done in prefabricated factory for constructing a concrete wall with cladding elements in the following way:
opening (aligning) the anchors to 90° relative to surface of the cladding elements;
placing a plurality of elements within a horizontal frame, where the front side of the elements (the outer side of the construction wall) is placed in the frame, so that the anchors protrude upwards;
placing (overlaying) a reinforcement steel net; and
casting concrete over the net and elements.

In this method, the anchors are “submerged” in the fresh concrete and after curing are used to hold the cladding elements attached to the construction wall.

In another non-limiting embodiment, the cladding elements are attached to a support wall of a building onsite. In such method the cladding elements are placed in a frame, which may be horizontal or inclined, where the front side of the cladding elements face the frame distal face and the anchors face up. A system, e.g., an array, of rods holds the anchors, and the frame is lifted by a lever, of a crane for example, to the area of casting the wall. When the frame is in place (at the casting area there is steel constructive reinforcement), a second frame is located at the distal/opposite side beyond the reinforcement facing the interior of the construction. Casting fresh concrete between the two frames “submerges” the erect, vertically lifted part of the anchors in the fresh concrete. After finishing, the anchors fix the cladding elements to the wall and generate a stress-strain characteristic that enables the wall to carry the load of the cladding elements under varying conditions.

In still another particular embodiment, a third method is provided for onsite attachment of the cladding elements to a construction wall with “wet” cement cover on an existing construction wall as follows:
placing a reinforcement net on the wall and fixing it with screws or other mechanical attachment means;
assembling cladding elements when the anchors are open and protrude towards the wall in 90° angle relative to the surface of the cladding elements;
tying the anchors (only when required) to the reinforcement net; and
casting concrete mortar between the cover and wall.

The exposed vertically oriented parts of the anchors are “submerged” (“sunken”) in the mortar, and after finishing hold the cladding elements fixed to the wall.

In general, the weight of the cladding elements per one square meter is about 75 kg. The number of anchors per meter is between 20 and 40 per one square meter. The strength of pulling a single anchor (in lab tests) is found to be between 140 and 250 kg.

No tearing, rupture or breaking was found in strength tests done to the anchors. These strength levels are found sufficient according to planning and regulation demands with significantly large margins.

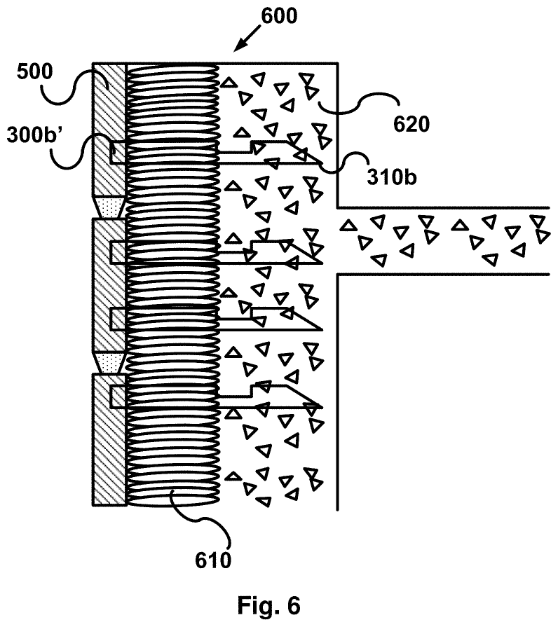

FIG. 6 illustrates a system 600 with an external wall 620 covered with cladding elements 500 attached to the wall 620 with a plurality of anchors 300. The anchors 300 end with sharp edge 310c to improve fastening the cladding elements 500 to the wall 620. In addition to the existing cladding installation system, namely cladding elements 500 including anchors 300 attached to wall 620, behind the cladding a thermal insulation mattress (or board) 610 is introduced that divides between the cladding elements 500 and wall 620. Such mattress/board 610 fits to a precast concrete element or “in situ” casting. In this case, the anchors 500 can be longer, thicker and with a sharp edge, e.g., 310c, to allow an easy “Go Through” of the anchors into the mattress and be anchored to the concrete wall 610 when casting (the precast or “in situ” concrete).

1.-43. (canceled)

44. A machine for manufacturing anchor embedded cladding element comprising:
a cladding block manufacturing machine; and
an anchor feeding and embedding machine comprising means for delivering said anchors to cladding block plate(s) in said cladding block manufacturing machine, said plates are filled with a “dry” concrete layer overlaid on a “wet” concrete layer,
wherein said concrete block manufacturing machine and anchor feeding and embedding machine are configured for coordinated operation for producing anchors embedded cladding elements comprising concrete blocks and anchors embedded within said blocks, wherein said anchor feeding and embedding machine is positioned near and at a relative level above a table carrying said plate(s) of said cladding block manufacturing machine and is configured to:
synchronize operation with said cladding block manufacturing machine and timely introduce said means for delivering said anchors above said cladding block plate(s) after said cladding block manufacturing machine overlays said “dry” concrete layer on said “wet” concrete layer in said plate(s);
embedding said anchors in said “dry” concrete layer by applying selected pressure to introduce one part of said anchors into said “dry” concrete layer and maintain another part of said anchors exposed on surface of said “dry” concrete layer and leveled with surface of said “dry” concrete layer, said parts are connected to each other with a bendable axis; and
retreating said means out of said concrete block manufacturing machine before said cladding block manufacturing machine moves said table carrying said plate(s).

45. The machine according to claim 44, wherein said anchor feeding and embedding machine comprises:
a stabilizing base configured for carrying a tray comprising anchors in a selected configuration;
a horizontal beam or arm which is configured for travelling a machine head device from said base to distal end of said beam or arm;
a machine head device which is configured for lifting and travelling said anchors from said tray and releasing them into said cladding block;
a tray configured to hold said anchors according to a selected plan of location of said anchors in said element; and
a compressed air system which is configured to push down and lift off said machine head device towards and from said tray and cladding blocks.

46. The machine according to claim 45, wherein said machine head device comprises vacuum mouthpieces, said machine further comprising a vacuum system, said vacuum mouthpieces are configured to lift and hold said anchors off of said tray with vacuum and release said anchors into said cladding blocks.

47. The machine according to claim 46, wherein means for pushing down and pulling up said machine head are selected from springs and air bags.

48. The machine according to claim 46, wherein said tray is configured to hold said anchors at selected positions for simultaneous embedding within said “dry” concrete layer of said cladding block, wherein said anchors comprise two parts, wherein one part is long and a second part is short relative to said long part, and bendable axis connecting said two parts, said anchors are mounted on said tray in L-shape 90° position.

49. The machine according to claim 44, wherein said parts comprise recesses and are configured for improved fastening to concrete of said cladding blocks and cement adhering to a support construction wall.

50. The machine according to claim 44, wherein edges of said parts are serrated, wavy or roughened for improved friction and fastening to concrete of said cladding block and cement adhering to a support construction wall.

51. The machine according to claim 44, wherein said anchors further comprise a blade, said blade is connected to the side of said long part of said anchor and disconnected from said short part and bending axis at its proximal end and is in 90° orientation relative to the long part on a X-Y plane and in 90° orientation relative to the short part on the Y-Z plane, said blade is inclined sharp at its distal end.

52. The machine according to claim 44, wherein said anchors further comprise a hole at a distal end of said long part, wherein said hole is configured to hold a thread or wire attached to said anchor on one side and a grid overlaid on said support construction wall on a second side, said hole providing mechanical strength to attachment of said cladding block to said support construction wall.

53. The machine according to claim 45, wherein said machine head device comprises electromagnet or magnet means for lifting said anchors off of said tray and travelling said anchors to and releasing them into said cladding blocks.

54. An anchor embedded cladding element comprising:
a cladding block comprising top “wet” concrete layer and bottom “dry” concrete layer;
a plurality of anchors in 90° orientation relative to surface of said bottom “dry” concrete layer of said cladding block, wherein one part of said anchors is embedded in said bottom “dry” concrete layer and another part of said anchors is exposed on said surface of said cladding block and leveled with surface of said “dry” concrete layer, said parts are connected to each other with a bendable axis.

55. The element according to claim 54, wherein faces of said anchors comprise recesses for improved adherence of said anchors in concrete of said cladding block.

56. An anchor for embedding in a cladding element, said anchor comprising a long part and a short part, said parts are in 90° orientation one relative to the other, and a bending axis between said long and short parts, wherein said short part of said anchor is configured to be embedded in a bottom “dry” concrete layer of said cladding element and said long part is exposed on a surface of said cladding element and leveled with a surface of said “dry” concrete layer.

57. The anchor for embedding in a cladding element according to claim 56, further comprising a blade, said blade is connected to a side of said long part of said anchor and disconnected from said short part and said bending axis at its proximal end and is in 90° orientation relative to the long part on a X-Y plane and in 90° orientation relative to the short part on the Y-Z plane, said blade is inclined sharp at its distal end.

58. The anchor for embedding in a cladding element according to claim 56, wherein faces of said anchors are serrated, wavy or roughened for improved adherence of said anchors in concrete of said cladding block.

59. The anchor for embedding in a cladding element according to claim 56, wherein said anchors comprise a part horizontally oriented relative to surface of said “dry” concrete layer and a part vertically oriented relative to surface of said “dry” concrete layer, wherein an edge of said horizontal part of said anchors is inclined sharp.

60. The anchor for embedding in a cladding element according to claim 56, wherein said anchors comprise a part horizontally oriented relative to surface of said “dry” concrete layer and a part vertically oriented relative to surface of said “dry” concrete layer, wherein an edge of horizontal part of said anchors is flat.
